(19) United States
(12) Patent Application Publication
(10) Pub. No.: US 2009/0015156 A1
(43) Pub. Date: Jan. 15, 2009

(54) LIGHTING ELEMENTS WITH SEGMENTED ELECTRODES

(75) Inventors: Wolfgang Otto Budde, Aachen (DE); Dirk Hente, Wurselen (DE)

Correspondence Address: PHILIPS INTELLECTUAL PROPERTY & STANDARDS, 3 BURLINGTON WOODS DRIVE, BURLINGTON, MA, 01803, US

(73) Assignee: KONINKLIJKE PHILIPS ELECTRONICS N.V., Eindhoven (NL)

(21) Appl. No.: 12/281,710

(22) PCT Filed: Feb. 28, 2007
(86) PCT No.: PCT/IB2007/050647

§ 371 Date: Sep. 4, 2008

(30) Foreign Application Priority Data
Mar. 9, 2006 (EP) 06110878.3

(51) Int. Cl. H01J 1/62

(52) U.S. Cl. 313/505

(57) ABSTRACT

An electroluminescent device. Providing atmosphere lighting is possible by an electroluminescent layer, and a first electrode layer arranged on a of the first side of the electroluminescent layer and a second electrode layer arranged on a second side, opposing the first side of the electroluminescent layer, for supplying charges to the electroluminescent layer, at least one first contact element for contacting the first eletrode layer with a charge supply, at least one second contact element for contacting the second electrode layer with the charge supply, wherein the first and second electric contact elements are arranged asymmetrically to each other such that the intensity of light emitted from the electroluminescent layer varies across its area.

The present patent application relates to electroluminescent (EL) devices.

Electroluminescent (EL) devices are typically devices comprising EL material. The EL material is capable of emitting light, when a current is passed through it. The material used for EL devices can be light emitting polymers or small organic molecules. Organic devices may, for example be organic light emitting diodes (OLEDs), which are known in the art. For activating the EL devices, current is applied to the EL material by means of electrodes disposed at surfaces of the EL material.

EL devices, such as OLEDs, comprise EL material disposed between electrodes. Upon application of a suitable voltage, current flows through the EL material from anode to cathode. Light is produced by radiative recombination of holes and electrons inside the EL material. Using different organic EL material, the color of light emitted from the EL device can be varied.

EL devices using organic EL material are suitable for large area lighting applications such as, for instance, general illumination. It is known to use a plurality of EL devices, combined into a tiled area having a large lighting area.

The size of single EL devices can be several square centimeters, and the size of a tiled area can be a plurality thereof. The EL devices are suitable to create flat direct-view luminaries used for general lighting, as well as for effect light, and atmosphere lighting.

For instance, for general lighting, the EL devices according to the art are designed such that a uniform distribution of light emission over the whole EL surface is obtained. This uniform distribution of light is obtained advantageously by using ring-shaped electrodes arranged within electrode layers of the EL devices. The light emitted from an EL device decreases with increasing distance from the electrode, as less current passes through the EL layer at these distances, and less light is output.

Atmosphere lighting, i.e. the creation of atmospheres in rooms using light, is gaining more and more attention in the art. Luminaries specifically suited for atmosphere creation are provided. Atmosphere lighting is characterized by dynamic control of light effects, and multi-colored light. Dynamics are typically considered as smooth transitions between colors and intensities.

As mentioned above, current EL devices are optimized such that an almost uniform light distribution over the given EL surface is obtained. However, for direct-view atmosphere creation, a controllable, uneven distribution of light may be favorable.

Therefore, it is an object of the present patent application to arrange the electrodes such that the perceived brightness is varying across the EL device area. A further object is to provide dynamic lighting using EL devices. Another object of the patent application is to realize soft pixels within an EL device.

These and other objects of the application are provided by an electroluminescent device comprising an electroluminescent layer, a first electrode layer arranged on a first side of the electroluminescent layer and a second electrode layer arranged on a second side, opposing the first side of the electroluminescent layer, for supplying charges to the electroluminescent layer, at least one first contact element for contacting the first electrode layer with a charge supply, at least one second contact element for contacting the second electrode layer with the charge supply, wherein the first and second contact elements are arranged asymmetrically to each other such that the intensity of light emitted from the electroluminescent layer varies across its area.

It has been found that arranging the contact elements asymmetrically to each other provides for uneven, but controllable light distribution within the EL device. The uneven light distribution can be obtained by arranging the contact elements on the electrode layers, independently whether anode layer or cathode layer. The uneven light distribution is obtained by an uneven current distribution within the electroluminescent layer. The uneven current distribution is provided by the asymmetrical arrangement of the contact elements.

The electroluminescent layer may preferably be an organic layer. The EL device may preferably be an OLED device.

The EL layer is bordered by first and second electrode layers. These electrode layers can be provided on opposing surfaces of the EL layer. The electrode layers preferably have a low ohmic resistance in order to distribute charges evenly applied onto the electrode layers into the EL layer.

The contact elements for contacting the electrode layers with a charge supply can be comprised at the electrode layers. Preferably, the contact elements may be embedded within the electrode layer, providing low height devices. The contact elements may also be of the same material as the electrode layer, but having a different ohmic resistance.

In order to obtain uneven distribution of light emitted from the EL layer, it is also preferred that contact elements on the electrodes layer may be arranged such that they are asymmetrically to each other. Asymmetrically to each other may result in that the arrangement of first contact elements on a first electrode layer is different to that of second contact elements on the electrode layer. In contrast to EL devices according to the art, where on both sides of the EL layer similar contact elements were arranged, preferably ring-shaped contact elements, the present patent application provides arranging the contact elements such that they may differ in size, and/or position, and/or shape, and/or orientation, and/or design from each other.

According to embodiments, the ohmic resistance of an electrode layer is less (<) or far less (<<) than the resistance of the respective contact elements arranged in the electrode layer. It is further proposed that the resistance of the cathode electrode layer is less than the resistance of the anode electrode layer. However, it may also be possible that the resistance of the anode layer, and the cathode layer are equal.

According to embodiments, a contact element is arranged as a contact point on an outer edge of an electrode layer. The contact point may be a small strip located at an outer edge of the electrode layer. It is preferred that two of such contact points may be arranged at opposing edges of an electrode layer, preferably in an anode layer.

It is further preferred that the contact points may be arranged within corners of an electrode layer, preferably within two opposing comers of the electrode layer, preferably in the anode layer.

According to embodiments, arranging the contact element as a stripe extending from edge to edge of an electrode layer may also be preferred. Further preferred is to arrange a strip as contact element, which is located in the middle of the electrode layer, and does not extend to an edge of this layer.

According to embodiments, the second contact element may be a contact ring arranged along the outer edges of the second electrode layer. Depending on which layer the contact point or strip is arranged, on the respective other electrode layer the contact ring may be arranged.

According to embodiments, a plurality of rows can build the first contact elements, and a plurality of columns, perpendicular to these rows, and arranged on the respective other side of the EL layer, can build the second contact elements. At areas, where the columns and the rows intersected each other, a pixel element can be created. A pixel element can be considered as a point on the EL devices emitting light. Due to the current path at the intersections of the rows and columns, at these positions the most light is emitted by the EL device.

It may also be provide to vary the ohmic resistance of the contact elements. Preferably, the resistance of the contact elements may be low at intersecting areas, and high at other areas of the contact elements. By providing a resistivity gradient, an additional gradient of emitted light may be provided.

Further advantages of the present patent application may be derived from the claims.

These and other aspects of the invention will be apparent from and elucidated with referenced to the following Figures.

### BRIEF DESCRIPTION OF THE DRAWINGS

In the Figures show:

FIG. 1 a simplified EL devices structure with symmetric contact elements;

FIG. 2 a contour plot of light output on an EL device according to FIG. 1;

FIG. 3 an arrangement of contact elements on anode and cathode electrode layers;

FIG. 4 a contour plot of light output of an EL device according to FIG. 3;

FIG. 5 an arrangement of contact elements according to embodiments;

FIG. 6 a contour plot of light output of an EL device according to FIG. 5;

FIG. 7 an arrangement of contact elements according to embodiments;

FIG. 8 a contour plot of light output of an EL device according to FIG. 7;

FIG. 9 a further arrangement of contact elements according to embodiments;

FIG. 10 a contour plot of light output of an EL device according to FIG. 9;

FIG. 11 a further arrangement of contact elements according to embodiments;

FIG. 12 a contour plot of light output of an EL device according to FIG. 11;

FIG. 13 a current distribution plot for applying current to an EL device according to FIG. 11;

FIG. 14 a contour plot of light output of an EL device according to FIG. 11;

FIG. 15 a further arrangement of contact elements according to embodiments;

FIG. 16 a contour plot of light output of an EL device according to FIG. 15;

FIG. 17 an EL device comprised of a pattern of a plurality of EL device tiles.

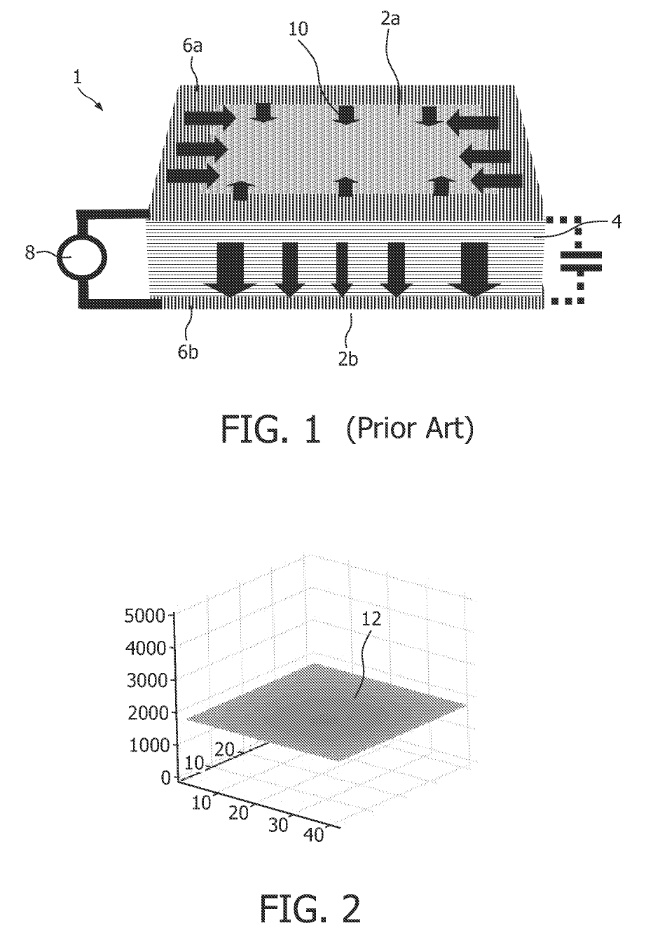

FIG. 1 illustrates an EL device 1, preferably an OLED device as known in the art. For reasons of simplicity, illustrated is a top emitting OLED as a three-layer structure.

Illustrated is an OLED 1 with an anode layer 2a, and a cathode layer 2b. Between anode layer 2a, and cathode layer 2b, an electroluminescent layer 4, preferably an organic EL layer 4 is arranged and may for example, also contain one ore more hole- and/or electron-conducting layers.

Anode layer 2a and/or cathode layer may be transparent. The ohmic resistance of anode layer 2a and cathode layer 2b is preferably low. Anode layer 2a has the ohmic resistance Ra and cathode layer 2b has the ohmic resistance Rc. Anode layer 2a, and cathode layer 2b preferably cover two opposing surfaces of EL layer 4. Anode layer 2a preferably comprises indium-tin-oxide (ITO) as transparent electrode material. Cathode layer 2b may be made from metal, preferably a metal with low work function such as LiF/Al.

The EL device 1 is connected to a current source 8 by means of contact elements 6a, 6b. The contact elements 6a, 6b are deposited on the anode layer 2a, and the cathode layer 2b, respectively. According to the art, the contact elements 6 are ring-shaped. Both contact elements 6 have the same shape, and are arranged on opposing sides of the EL layer 4. For best current uniformity within the EL device 1, the contact elements 6 extend along the peripheral edges of both the anode layer 2a, and the cathode layer 2b.

This type of “ring injection” enables to provide an almost uniform current distribution throughout the EL layer 4. The higher the conductivity of the anode layer 2a, and cathode layer 2b, the more even is the current distribution.

The distribution of emitted light from the EL device 1 depends on the current within the EL layer 4. An even current distribution provides for even light emission.

As illustrated in FIG. 2, the light output of a square shaped EL device 1 with a current ring injection shown in FIG. 1 is uniform. Illustrated in FIG. 2 is the amount of emitted light over the surface of the EL device 1. As can be seen from plane 12, the EL device according to FIG. 1 has an even light distribution.

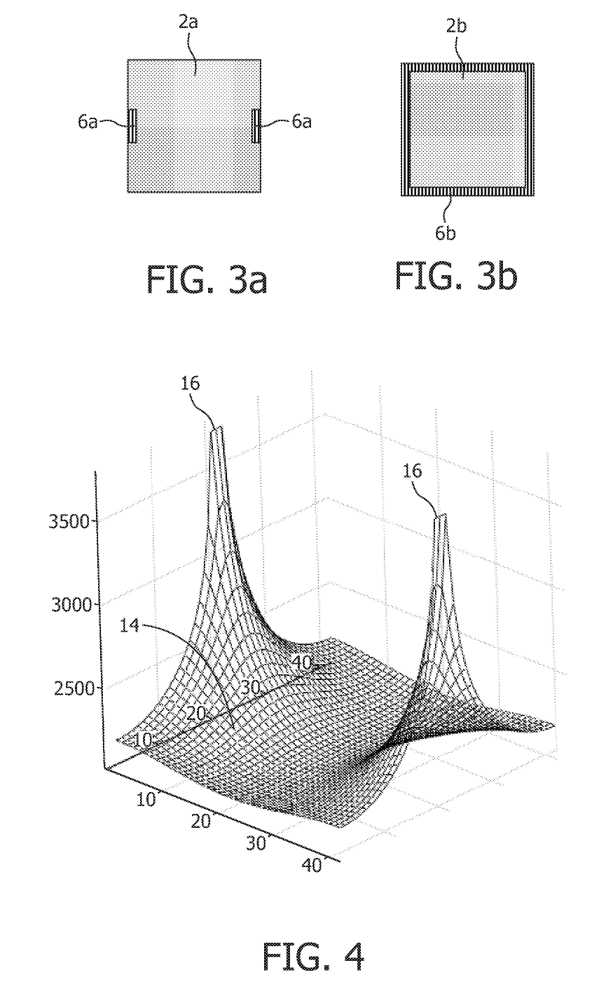

In order to provide atmosphere lighting, uneven light distribution is desirable. Therefore, according to embodiments, an arrangement according to FIG. 3 is provided. As illustrated in FIG. 3a, the anode layer 2a is contacted with contact elements 6a, which contact elements 6a are contact points. The cathode layer 2b is contacted to the current source 8 by means of contact element 6b.

A contact element according to the patent application may be understood as an element, which has a resistance Rcontact, which is different from the resistance of the electrode material (Ra, Rc). The contact element material may be either of the same or of different material like the corresponding electrode. The contact element may have a resistance, which is significantly smaller or larger than the corresponding electrode.

In case contact element and electrode material are made of the same material, the resistance of contact element may be adjusted by adjusting the material layer height. For example, a low ohmic contact area on the ITO may be achieved by first depositing ITO on glass at a specific thickness t1 and then depositing a small strip of ITO of a different thickness t2 on the first ITO layer.

In case contact element and electrode material are made of different material, the contact area may be made from a metal, like Cu or Ag. In case of the ITO area the contact area may be transparent as well. In this case, the metal may be of very small thickness or a set of small invisible lines or grids deposited on the ITO layer. The size of the lines and or grid may be made in such a way that light may emit through it but at the same time the lines/stripes are invisible to the human eye.

Contact layers can be formed during and/or after depositing of the electrode material e.g. by vapor deposition, evaporation, spraying, printing, coating and the like. The contact layers may be either made of homogeneous material and/or inhomogeneous material, such as, for example stripes, grids or any type of suitable structuring to modulate the resistance on the contact area. Using a grid-like contact layer can be advantageous for the ITO layer where the transparency is required. Moreover, the contact area may be formed of a stack of different materials.

As can be seen, the contact elements 6a are arranged in the middle of opposing edges of the anode layer 2a. The resistance of contact element 6a is less than the resistance of anode layer 2a. The contact elements 6a are asymmetrically arranged to ring-shaped contact element 6b, illustrated in FIG. 3b.

An arrangement according to FIG. 3a, FIG. 3b accounts for uneven current distribution within the EL layer 4. This uneven current distribution provides for uneven light output in the EL device 1, as illustrated in FIG. 4. As can be seen from FIG. 4, the light distribution is represented by plot 14. At positions 16, which correspond to the positions of the contact element 6a, the light output is much higher than away from the contact element 6a. The light output decreases with increasing distance from the contact elements 6a. The steepness of decrease of light output may be a function of the resistance of the contact element 6a, and the anode layer 2a. The higher the resistance Ra of the anode layer 2a, the steeper the decrease of light distribution array from the positions 16. The light output may further depend on the IV-characteristic of the EL layer.

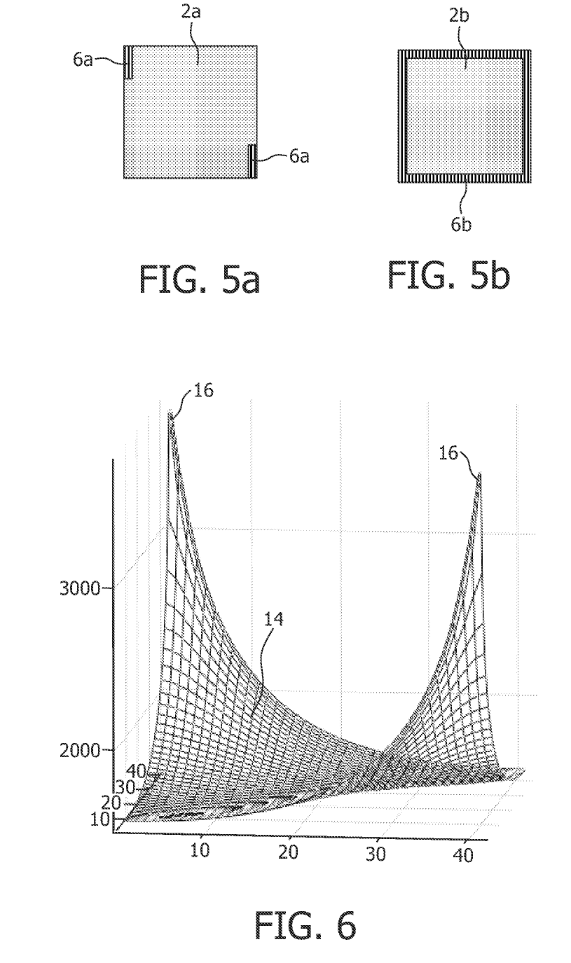

FIG. 5a illustrates another possible arrangement of contact elements 6a in opposing comers of the anode layer 2a. The contact element 6b, as illustrated in FIG. 5b, is ring-shaped arranged on cathode layer 2b.

FIG. 6 illustrates the light distribution, which again follows the current distribution within the EL device 1. At positions 16, the light output is higher than other positions. Positions 16 correspond to positions of contact elements 6a.

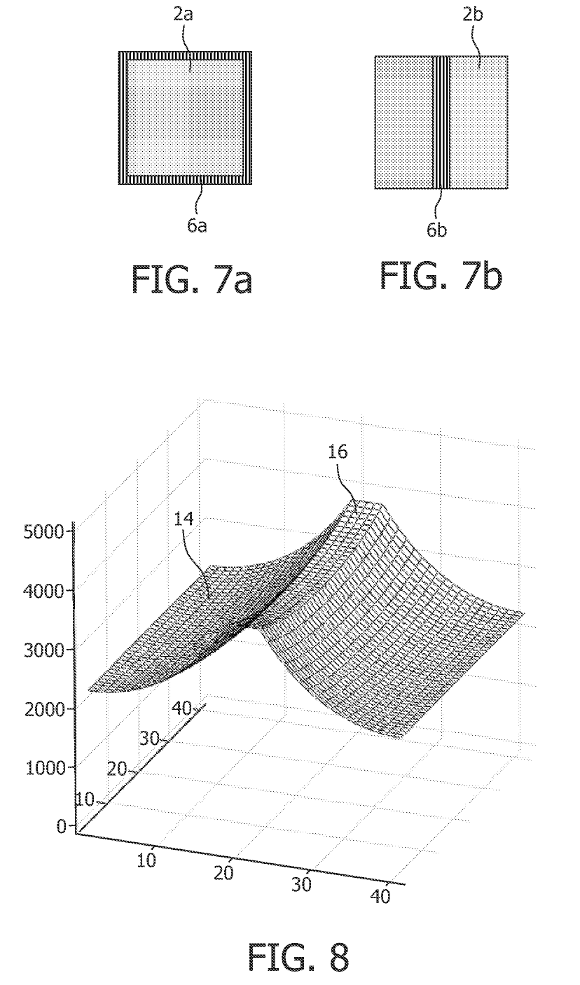

FIG. 7 illustrate a further arrangement of contact elements 6. As illustrated, embedded within anode layer 2a, a ring-shaped contact element 6a is arranged. As illustrated in FIG. 7b, a contact element 6b is arranged as strip extending from one edge of the cathode layer 2b to the corresponding other edge. The resistance of the contact element 6b can be far less than the resistance Rc of the cathode layer 2b. The contact element 6b can be connected to ground, whereas the contact element 6a can be connected to a driving potential, or vice versa.

As a result, as illustrated in FIG. 8, the light distribution has an elevation at position 16 along the direction of contact element 6b.

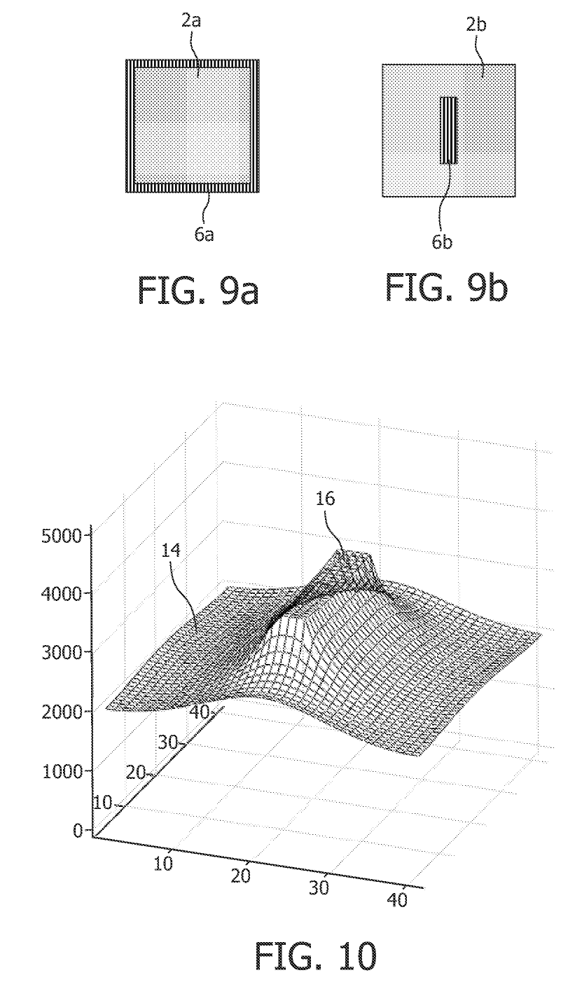

Illustrated in FIG. 9, is a further arrangement. The anode layer 2a is contacted through a ring-shaped contact element 6a, as illustrated in FIG. 9a. The cathode layer 2b is contacted by means of a strip-shaped contact element 6b. Again, as within all other embodiments, the resistance of the contact element 6b can be chosen far less than the resistance Rc of cathode layer 6b (Rcontact<<Rc). It may also be possible to choose the resistance Ra of anode layer 2a similar to the resistance Rcontact of contact elements 6.

As illustrated in FIG. 10, at position 16, the light distribution has an elevation due to the higher current flow near the contact element 6b, whereas the current flow away from contact element 6b is reduced.

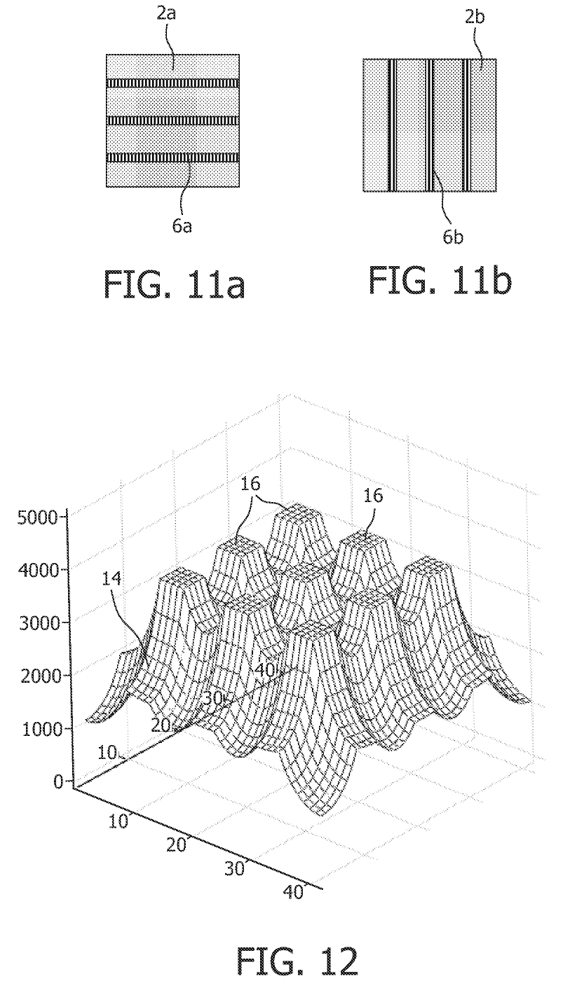

FIG. 11 illustrate a further arrangement of contact elements 6. As can be seen in FIG. 11a, contact elements 6a are arranged as rows. Contact elements 6b are arranged as columns, as illustrated in FIG. 11b.

The anode layer 2a together with the contact elements 6a is arranged on an opposing side of the EL layer 4 to the cathode layer 3b with the contact elements 6b. The rows and columns of the contact elements 6 have, seen in a top view, intersections, i.e. intersection areas. The current distribution is such that the current flow is highest as the position of the intersection, and decreases with the distance from the intersections.

As illustrated in FIG. 12, positions 16 represent the light output at the intersection areas when all contact elements 6 are connected to a driving source. At these positions, the light output is highest, and the light output decreases with increasing distance from the intersections. The current flow through each of the rows, and columns can be driven independently from each other. Connecting a driving source to the n-th row, and the m-th column, the light output is generated at the intersection of these contact elements. By proper selection of Rc and Ra and resistance of contact elements 6 on the anode and cathode layer, a smooth light distribution maybe obtained, as illustrated in FIG. 12.

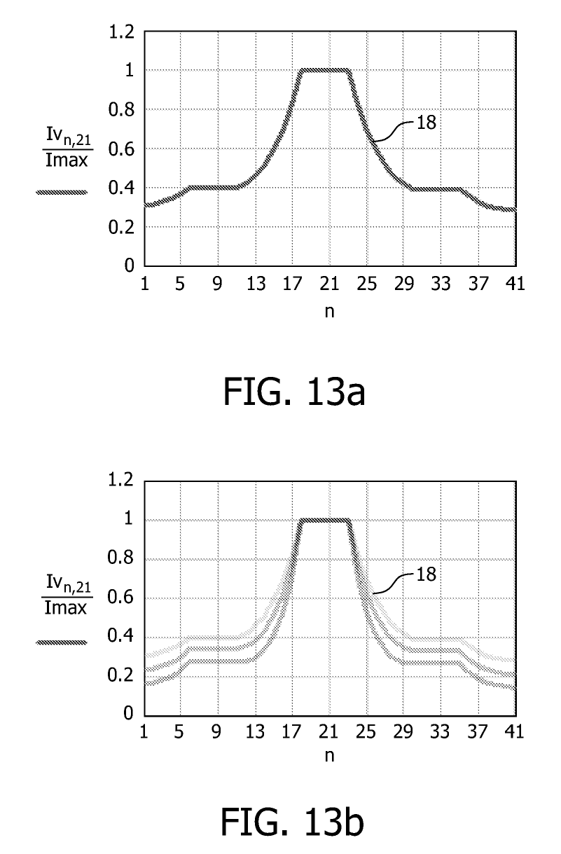

As illustrated in FIG. 13, and already mentioned above, the current flow through each of the contact elements can be controlled individually. FIG. 13a illustrates along its abscissa the physical extension of a square shaped EL device. Along its ordinate, the absolute value of current flow through the light emitting layer 4 is illustrated. In the illustrated example, a driving source is connected to row n=2 and column m=2 while the remaining rows and columns are floating, i.e. they are not connected to a driving source.

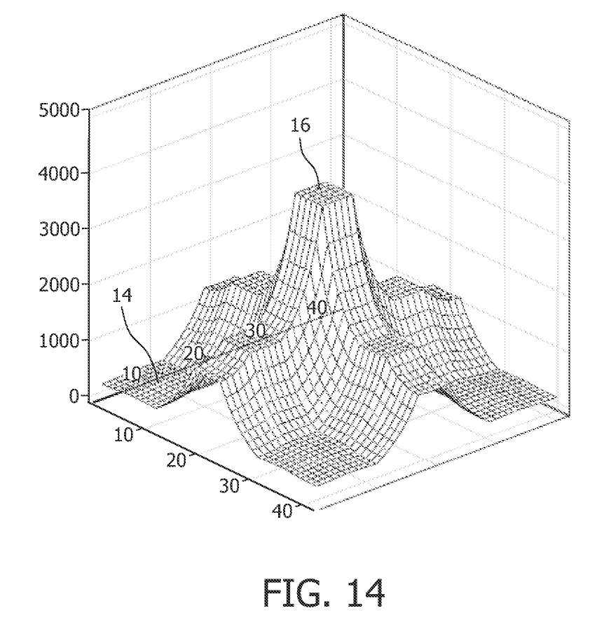

FIG. 13b illustrates that the current 18 can be adjusted. It should be noted that the light distribution is a function of the current flow from the cathode layer 2b to the anode layer 2a through the EL layer 4. Thus, the higher the current flow between row and column at an intersection, the higher the light output. As illustrated in FIG. 14, a light output depends on the current flow adjusted for each of the rows/column. As can be seen, at position 16, corresponding to the intersection of row 2 with column 2, the light output is highest. The steepness of slope 14 representing light output can be adjusted by adjusting the current flow 18. By increasing the maximum current flow, the light output can be increased.

FIG. 14 shows that the light output is the highest at the intersection of both activated contact elements n=m=2. The light output drops with increasing distance from the intersection. At the remaining 8 intersections the light output form a plateau like behaviour which is due to the fact that the voltage across the El layer is almost constant due to the low ohmic floating contact elements.

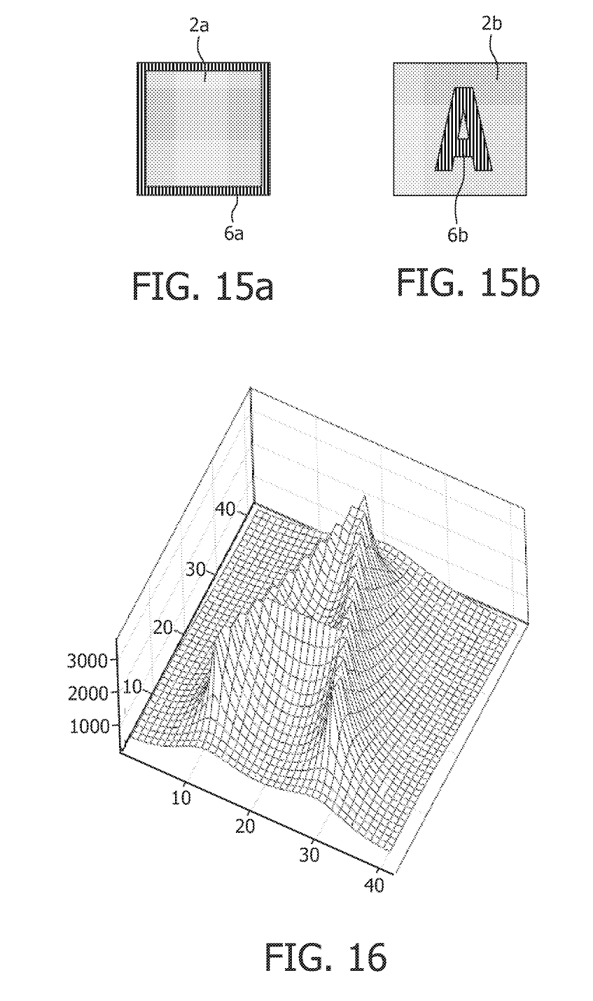

According to embodiments, as illustrated in FIG. 15, special shapes can be generated using specially formed contact elements 6. As illustrated in FIG. 15a, contact element 6a is ring-shaped, whereas, as illustrated in FIG. 15b, contact element 6b is letter-shaped.

The light output, following the current flow, is illustrated in FIG. 16. As can be seen, the shape of the contact element 6b is imaged within the light output.

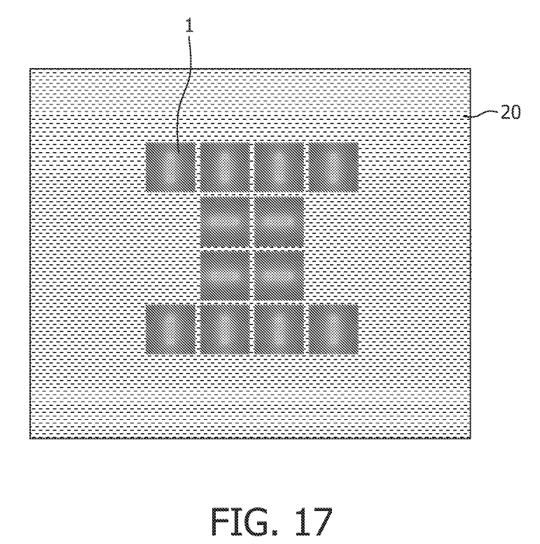

FIG. 17 illustrates a tiled area of EL elements 1. The area 20 can be comprised of an array of EL elements 1, each of which providing a lighting effect. Each EL element 1 can provide a different effect, thus forming an area 20 capable of providing a plurality of optical effects.

It may also be possible to provide EL elements 1 with different colors. Stacking these colored EL elements on top of each other, and providing the contact elements asymmetrically on the EL elements, color effects with different colors are possible. It is further possible, to control the contact elements of the layers individually, enabling multi-colored light gradients across the surface of a stacked EL device.

While there have been shown and described and pointed out fundamental novel features of the invention as applied to a preferred embodiment thereof, it will be understood that various omissions and substitutions and changes in the form and details of the devices and methods described may be made by those skilled in the art without departing from the spirit of the invention. For example, it is expressly intended that all combinations of those elements and/or method steps, which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto. It should also be recognized that any reference signs shall not be constructed as limiting the scope of the claims.

1. An electroluminescent device comprising
an electroluminescent layer,
a first electrode layer arranged on a first side of the electroluminescent layer and a second electrode layer arranged on a second side, opposing the first side of the electroluminescent layer, for supplying charges to the electroluminescent layer,
at least one first contact element for contacting the first electrode layer with a charge supply, and
at least one second contact element for contacting the second electrode layer with the charge supply,
wherein the first and second contact elements are arranged and configured relative to each other such that the intensity of light emitted from the electroluminescent layer varies across its area and wherein at least two of the first contact elements are arranged as rows extending from one edge of the first electrode layer to the other edge and at least two of the second contact elements are arranged as columns extending from one edge of the second electrode layer to the other edge and perpendicular to the first contact elements arranged as rows.

2-9. (canceled)

10. The electroluminescent device of claim 1, wherein at least one of the electrode layers comprises a metal or metal-oxide.

11. The electroluminescent device of claim 1, wherein the first and second contact elements differ from each other in at least one of size, shape, or orientation.
